(19) United States
(12) Patent Application Publication
(10) Pub. No.: US 2017/0149696 A1
(43) Pub. Date: May 25, 2017

(54) CONNECTION CLASSIFICATION

(71) Applicant: HEWLETT PACKARD ENTERPRISE DEVELOPMENT LP, Houston, TX (US)

(72) Inventor: Justin E. York, Cypress, TX (US)

(21) Appl. No.: 15/115,854

(22) PCT Filed: Apr. 10, 2014
(86) PCT No.: PCT/US2014/033644

§ 371 Date: Aug. 1, 2016

(51) Int. Cl. H04L 12/931; H04L 12/833; H04L 12/823; H04L 12/46

(52) U.S. Cl. CPC H04L 49/40; H04L 12/4641; H04L 47/31; H04L 47/32

(57) ABSTRACT

In one aspect a chassis manager may receive connection classifications from a cartridge. The connection classifications may determine desired network connectivity of the cartridge. A network switch may receive the connection classifications from the chassis manager. The network switch may further configure network connectivity of the cartridge based on the connection classification.

### BACKGROUND

Modern high performance computing systems may include a chassis which houses multiple computing resources. These computing resources may be in the form of cartridges. In essence, each cartridge may be an independent computer, and contain many of the elements that make up a computer. For example, each cartridge may include one or more processors, memory, persistent storage, and network interface controllers. Each cartridge may include all or only some of the previously mentioned elements.

In addition, the chassis itself may provide resources that are shared by the cartridges within the chassis. For example, the chassis may provide one or more power supplies, which may be used to power the cartridges. Likewise, the chassis may provide cooling resources, such as fans, to cool the chassis and the cartridges within the chassis. The chassis may also provide networking resources to allow the cartridges to communicate with computing resources located both within and external to the chassis.

### BRIEF DESCRIPTION OF THE DRAWINGS

FIG. 1 depicts an example cartridge based chassis system that may utilize the connection classification techniques described herein.

FIG. 2 depicts another example cartridge based chassis system that may utilize the connection classification techniques described herein.

FIG. 3 is example of a high level flow diagram for connecting a cartridge to a network connection utilizing the connection classification techniques described herein.

FIG. 4 is another example of a high level flow diagram for connecting a cartridge to a network connection utilizing the connection classification techniques described herein.

### DETAILED DESCRIPTION

Some cartridges in a chassis may be designated to provide production workloads. Production cartridges in a chassis may be connected to an external network, which may also be called a production network. The production network is the network that may provide the cartridge with connectivity to the external world. For example, the external network may be an intranet or the Internet. One example application may be a chassis full of cartridges that are running web servers. Each of the cartridges may be referred to as a production cartridge and may be coupled to the Internet via the production network.

The chassis may also include a set of components that communicate via an infrastructure network. For example, shared elements, such as fans and power supplies may need to communicate with each other and other components within the chassis. In addition, there may be certain cartridges, which may be referred to as infrastructure cartridges, that need to communicate over the infrastructure network. For example, a firewall cartridge may be used to provide firewall services. This firewall cartridge may need to communicate over the infrastructure network and the production network, or possibly the production network alone. In some cases, an infrastructure cartridge may need the ability to form an independent network with other cartridges of the same type that is independent of the infrastructure network.

A problem may arise when an infrastructure cartridge needs to establish isolated network connections to other infrastructure cartridges, or to the infrastructure network of the chassis. Although it may be possible to provide a user with the ability to manually configure the desired connections for infrastructure cartridges, such manual configuration may be prone to user error. For example, the user may improperly configure an infrastructure cartridge to access the production network, or a production cartridge to access the infrastructure network. Further exacerbating the problem is that a user, even absent ill intent, may improperly configure a production cartridge in such a manner that the integrity of the infrastructure network is compromised. For example, in the case of a firewall infrastructure cartridge, a connection to the production network may be improperly configured, thus subjecting the firewall infrastructure cartridge to attack from the production network.

The techniques described herein overcome these problems through the use of a connection classification that is included With each cartridge, be it a production cartridge or an infrastructure cartridge. The connection classification is stored on each cartridge such that it is not readily modifiable by the user. For example, the connection classification may be set at the factory and the user is not provided with any capabilities to change the connection classification. In other examples, the distribution of any tools or utilities needed to change the connection classification may be restricted. What should be understood is that the connection classification is generally set by the cartridge vendor and cannot be readily changed by the end user of the cartridge.

The connection classification may be used by the chassis to determine to which networks the cartridge is allowed to connect. The chassis may retrieve the connection classification from the cartridge and only permit connection to the determined networks. The chassis may further restrict access to the networks from external sources by examining characteristics of the traffic and determining if the traffic is to be allowed access to the network or is to be ignored. Because the connection classification cannot be readily modified by the user, the cartridge vendor is able to specify to which networks the cartridge is allowed to connect, and that specification cannot be easily overridden by the end user.

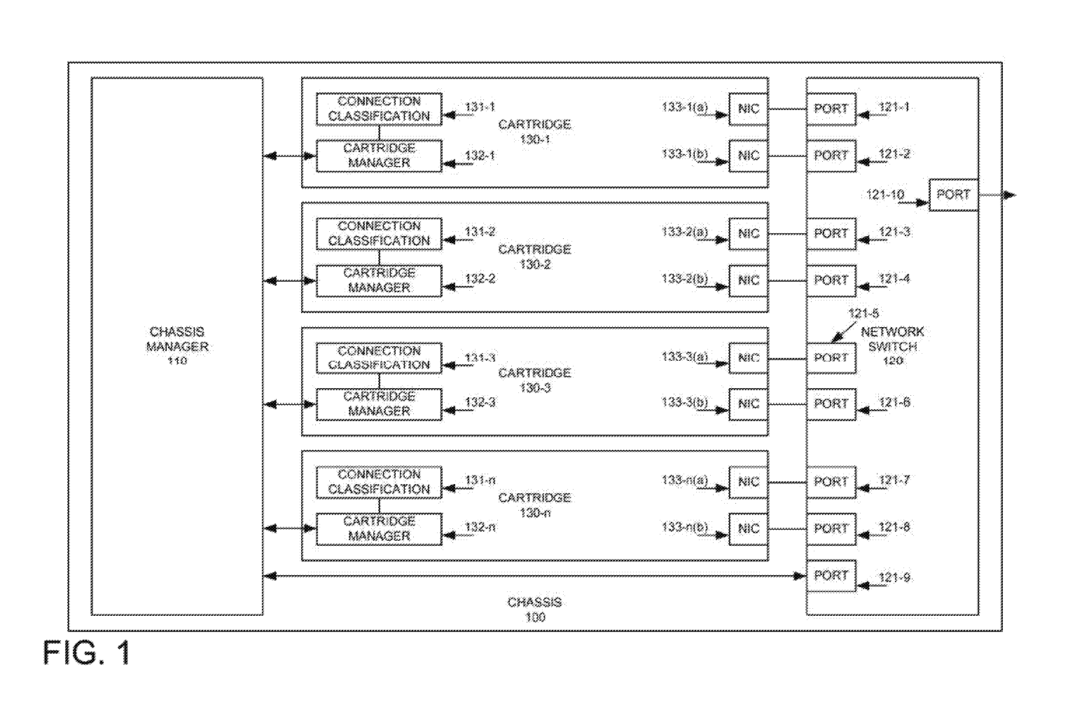

FIG. 1 depicts en example cartridge based chassis system that may utilize the connection classification techniques described herein. Chassis 100 may include a chassis manager 110, a network switch 120, and cartridges 130-1 . . . n. It should be understood that the chassis 100 described herein is merely an example, and that the techniques described herein are not dependent upon a single chassis manager, switch, or any defined number of cartridges. For example, a chassis may have more than one chassis manager or may have more than one network switch. In addition there may be any number of cartridges

The chassis manager 110 may provide management controller capabilities to the chassis and the cartridges within the chassis. For example, the chassis manager may provide connections to an external management network (not shown) that allows the chassis manager to configure the cartridges as well as monitor the operations of those cartridges. The chassis manager may provide functionality similar to that provided by a Baseboard Management Controller in a rack mount server. The chassis manager may be coupled to each of the cartridges 130-1 . . . n. In some example implementations, the connection between the chassis manager and the cartridges may be a direct connection or may be a connection over a private network. The particular form of the connection is unimportant, but what should be understood is that the chassis manager is able to communicate with the cartridges. In addition, the chassis manager may be coupled to a network switch 120. Again, the particular form of the connection is unimportant, but rather it should be understood that the chassis manager may communicate with the network switch.

The cartridges 130-1 . . . n may provide the computing resources. For example, the cartridges may include processors, memory, persistent storage, and network interface controllers (NIC) or any subset of those components. For simplicity of description, components such as the processor, memory, and persistent storage are not shown. What should be understood is that each cartridge (in conjunction with the chassis) may contain the components needed to provide the functionality of a standalone server. For example, the cartridge may contain the previously mentioned computing components, while receiving power and cooling resources from the chassis.

Each cartridge may include a cartridge manager 131-1 coupled to a connection classification 132-1 store. The cartridge manager may be a processor, a microcontroller, a complex programmable logic device (CPLD), a field programmable gate array (FPGA), or any other suitable device. The connection classification store may be any suitable persistent storage component that is capable of storing connection classification information. Some examples of suitable components may include FLASH memory, SRAM, Memristor based memory, electronically erasable programmable memory (EEPROM), or any other component suitable for storing a connection classification. Write access to the connection classification store may be restricted. For example, write access to the connection classification may be restricted to the vendor that provides the cartridge. What should be understood is that the end user typically does not have a readily accessible mechanism for modifying the data stored in the connection classification store. Because write access to the connection classification store is limited, for purposes of this description it may be assumed that the connection classification stored therein is correct and has not been improperly modified.

The cartridge manager may be coupled to the connection classification store such that the cartridge manager may retrieve the connection classification. The cartridge manager may further be used to communicate the connection classification to the chassis manager. It should be understood that the techniques described herein are not dependent on any particular type of component used for the chassis manager, cartridge manager, or connection classification store. Any components that allow storage of a connection classification on a cartridge, retrieval of the connection classification by a cartridge manager, and transmitting the connection classification to a chassis manager, over any type of dedicated or shared connection are suitable for use with the techniques described herein.

Each cartridge 130-1 . . . n may also include one or more network interface controllers (NIC)s 133-1 . . . n(a,b) For purposes of this description, each cartridge is shown with two NICs, however it should be understood that the techniques described herein are not dependent on any particular number of NICs. Each NIC may be coupled to a port on a network switch 120, as described below. The network switch may determine to which network each NIC connects, which in turn determines to which networks the cartridge is able to connect.

The network switch 120 may contain any number of ports 121-1 . . . n. For purposes of this description, a finite number of ports are shown, however it should be understood that the techniques described herein are not limited to any number of ports. As shown, ports 121-1 . . . 8 may be coupled to the NICs 133 of the cartridges 130, thus allowing the cartridges to access networks that are connected to the switch 120. Port 121-9 may be coupled to the chassis manager, thus allowing the chassis manager 110 to communicate with the network switch. For example, the chassis manager may communicate connection classification information from each cartridge to the network switch. Network switch may also include port 121-10 which is coupled to an external network (not shown) which may also be referred to as a production network. For purposes of this description, the production network is a network that is accessible by production cartridges. This is in contrast to vendor networks or infrastructure networks, which are described in further detail below. In some cases, the production network may be connected to a larger network, such as the Internet.

In operation, upon powering up, the cartridge manager 131-1 may read the connection classification information stored in the connection classification storage 132-1. The connection classification may include information such as the number of NICs 133 contained on the cartridge, and to which networks those NICs are to be connected. The cartridge manager may communicate the connection classification information to the chassis manager 110.

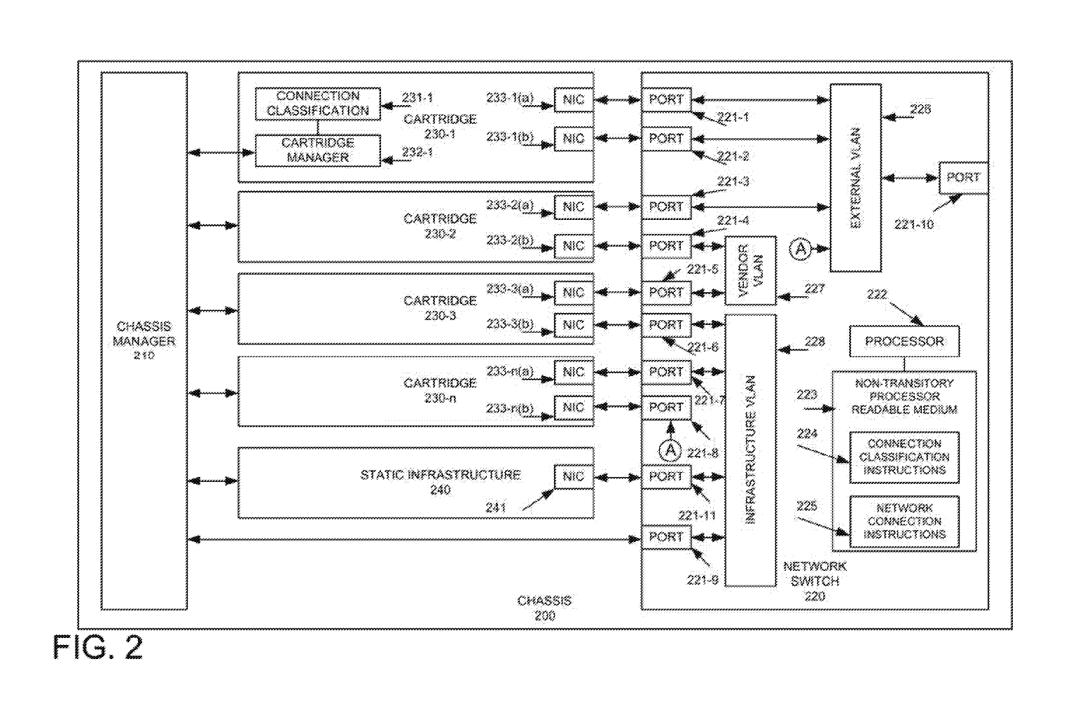

The chassis manager 110 may receive the connection classification information from the cartridge 130-1. The chassis manager may communicate the connection classification information to the network switch 120. The network switch may then use the connection classification information to enable the ports 121 that are connected to the NICs 133-1(a,b) of the cartridge 130. The connection classification information may be used to determine to which network each port 121 of the network switch 120 is connected. Isolation of the networks is described in further detail below, with respect to FIG. 2.

FIG. 2 depicts another example cartridge based chassis system that may utilize the connection classification techniques described herein. The elements depicted in FIG. 2 are similar to those in FIG. 1. For example, the chassis 200, chassis manager 210, cartridges 230, network switch 220, and the components contained therein are similar to the chassis 100, chassis manager 110, cartridges 130, and network switch 120 shown in FIG. 1. For purposes clarity, the description of those elements is not repeated with respect to FIG. 2.

In addition to the elements previously discussed, chassis 200 may also include static infrastructure 240. This static infrastructure may include elements that are used for general support functions of the chassis 200. For example, things such as power supplies and cooling fans may report status or be configured by the chassis manager. As such, these static infrastructure components may be connected to a network that is accessible by the chassis manager over an infrastructure network. However, these elements should have no need to be connected to external networks, such as production networks. Isolation of the various networks is described in further detail below.

The network switch 220 may include a processor 222. Coupled to the processor may be a non-transitory processor readable medium 223 containing thereon a set of instructions, which when executed by the processor cause the processor to implement the techniques described herein. For example, the medium may include connection classification instructions 224 and network connection instructions 225. The connection classification instructions may include instructions to allow the network switch to receive the connection classifications from the cartridges and act on the received classifications as appropriate. The network connection instructions may cause the processor to set up and enforce various networks, as is described in further detail below.

Network switch 220 may also contain constructs to form several different virtual local area networks (VLAN). For example, the network switch is shown as containing an external VLAN 226, a vendor VLAN 227, and an infrastructure VLAN 228. It should be understood that three VLANs are shown for purposes of description and not by way of limitation. The techniques described herein are not limited to the number or type of VLANs that are shown. A VLAN is a technique used by network switches to isolate network traffic that may be sharing the same physical switch. In a typical VLAN, each packet may be tagged with an identifier, which may be referred to as a VLAN identifier. Each port may likewise be associated with one or more VLAN identifiers. The network switch ensures that packets are only sent on ports that contain matching VLAN identifiers. For example, a port may be associated with a first VLAN identifier. A packet associated with a second, different VLAN identifier may not be sent on the port associated with the first VLAN identifier. Operation of VLANs is described in further detail below.

In operation, a cartridge 230 may be powered on. For example, cartridge 230-1 may be powered on. The cartridge manager 232-1 on the cartridge may read the connection classification 231-1. The cartridge manager may then communicate the connection classification information to the chassis manager. The connection classification information may indicate to which networks the NICs 233-1(a,b) are to be connected. For example, the connection classification information may indicate the NICs are to be connected to the default network, which may also be referred to as the external network, as defined by the external VLAN 226 identifier. The chassis manager may communicate the connection classification indication to the chassis manager 210. The network switch, using the connection classification instructions, may obtain the connection classification indication from the chassis manager.

The network switch may then configure the ports 221-1, 221-2 that are connected to the NICs 233-1(a,b) of cartridge 230-1 such that the ports are associated with the default network. Thus, all packets received by the ports 221-1, 221-2 may be tagged with the default VLAN identifier. Furthermore, port 221-10 may be connected the production network (not shown) and is also tagged with the default VLAN identifier. As such, packets received over ports associated with the external VLAN are able to communicate over the production network. Likewise, data packets originating from the production network are able to communicate with the NICs 233-1(a,b), because those NICS are identified by the connection classifications as belonging to the external VLAN.

A similar process may occur for cartridge 230-2. For ease of description, for the remainder of this description, the process of retrieving the connection classification by the cartridge manager, and sending the classification from the chassis manager to the network switch is not repeated. However, it should be understood that this process occurs for each cartridge whenever the cartridge is powered on. In the case of cartridge 230-2, NIC 233-2(a) may be associated with the external VLAN, just as above with respect to cartridge 230-1. Thus, the network switch may associate port 221-3 with the default VLAN identifier. Again, as above, the NIC 233-2(a) may then be associated with the production network.

However, the connection classification for NIC 233-2(b) may indicate that NIC 233-2(b) should belong to vendor VLAN 227. In one example implementation, the connection classification for a vendor VLAN may be indicated by a specific vendor ID, that is to be used by a given vendor. Thus, all NIC's which contain a connection classification including the vendor ID will be coupled together within the same vendor VLAN. It should be understood that although only one vendor VLAN 227 is shown, there may be any number of different vendor VLANs. For example, each vendor of a cartridge may establish their own vendor VLAN. As another example, a single vendor may have multiple vendor IDs, such that multiple vendor networks may be established even though the cartridges come from the same vendor. What should be understood is that the connection classification may be used to indicate that a NIC should be connected to a vendor VLAN.

In the present example with respect to cartridge 230-2 and NIC 233-2(b), the NIC is connected to port 221-4 on the network switch. The network switch, using the network connection instructions 225, may tag all packets arriving on port 221-4 with the VLAN identifier of the vendor VLAN. The port may also be associated with the vendor VLAN. Furthermore, the network switch may ensure that packets tagged with the vendor VLAN identifier are only sent to ports that are also associated with the vendor VLAN, as is described in further detail below.

Cartridge 230-3 may go through a similar procedure of transmitting the connection classification to the network switch as describe above. In this operational example, the connection classification for NIC 233-3(a) may indicate that the NIC is to be connected to the vendor VLAN. As such, the network switch may configure port 221-5 to tag all incoming packets with the VLAN identifier of the vendor VLAN and also associate the port with the vendor VLAN.

The association of NICs 233-2(b) and 233-3(a) with the vendor VLAN means that all packets entering the switch from those NICs, through respective ports 221-4 and 221-5 may be tagged with the VLAN identifier of the vendor VLAN 227. Once an incoming packet has been tagged With the vendor VLAN identifier, the tagged packet may only be sent to ports that are associated with the vendor VLAN. In this example, only ports 221-4 and 221-5 are associated with the vendor VLAN. Thus, a vendor network has been created between NICs 233-2(b) and 233-3(a) on cartridges 230-2,3. To further increase security, the network switch may discard any received packet that already contains a vendor VLAN identifier. This ensures that a malicious actor cannot access the vendor VLAN by sending packets through a different port (e.g. port 221-10 which is connected to the external network) that have already been tagged with the vendor VLAN identifier. In other words, security is increased because the network switch is the only entity that tags packets with a vendor VLAN identifier. Any packet received by the switch that has already been tagged indicates a fraudulent packet.

Continuing with the operational example, NIC 233-3(b) may have a connection classification indicating that the NIC should be connected to the infrastructure VLAN 228. As mentioned above, the chassis may include an infrastructure VLAN to enable communications between components within the chassis that are used for infrastructure purposes. Fans and powers supplies (not shown) are some examples of such components. The infrastructure VLAN may be similar to a vendor VLAN in that access is limited. In the case of the infrastructure VLAN, access may be limited to components such as static infrastructure 240 and the NIC 241 associated with the static infrastructure. It should be understood that static infrastructure 240 is not intended to depict a single device, but rather represents all components within the chasing that may utilize connection to the infrastructure network.

As mentioned above, NIC 223-3(b) may have a connection classification indicating that the NIC should be connected to the infrastructure VLAN 228. The network switch, again using the network connection instructions, may associate port 221-6 with the infrastructure VLAN. In addition, packets received over port 221-6 may be tagged with the VLAN identifier of the infrastructure VLAN. Just as above with respect to the vendor VLAN, traffic on the infrastructure VLAN is thus isolated from both the external VLAN 226 and the vendor VLAN 227.

Cartridge 230-n may have NIC 233-n(a) with a connection classification configured to connect to the infrastructure VLAN 228, while NIC 233-n(b) is configured to connect to the external VLAN 226.

It should be understood that the network connections described above are simply examples of the possibilities of connections to different networks. The techniques described herein are not limited to any particular set of network connections. For example, the connections described for several of the cartridges show one NIC of a cartridge connected to one network (e.g. the vendor network) while the other NIC is connected to a different network. In some cases, this may be desirable, as it provides the cartridge with the ability to bridge traffic between the two networks. In other cases, bridging the traffic may be undesirable. The techniques described herein determine network connections based on the connection classification and are flexible such that connections to network is left up to the cartridge vendor.

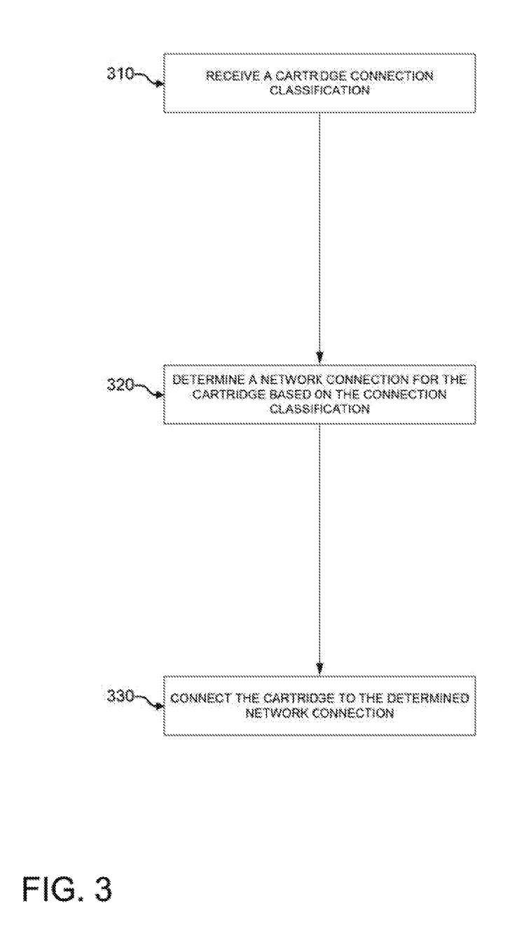

FIG. 3 is an example of a high level flow diagram for connecting a cartridge to a network connection utilizing the connection classification techniques described herein. In block 310, a cartridge connection classification may be received. As explained above, the cartridge connection classification may be stored on the cartridge and retrieved when the cartridge is initially powered on.

In block 320, a network connection for the cartridge may be determined based on the connection classification. The connection classification may determine to which networks each NIC on the cartridge should be connected to. For example the networks may be defined by VLANs. In block 330, the cartridge may be connected to the determined network connections. In some example implementations, the connection to the determined network may be through the use of VLAN tagging

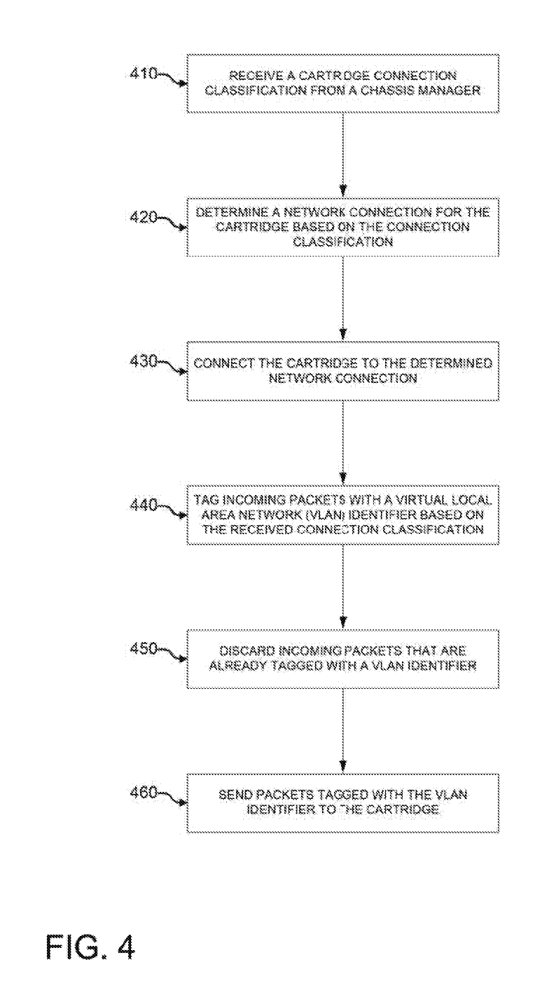

FIG. 4 is another example of a high level flow diagram for connecting a cartridge to a network connection utilizing the connection classification techniques described herein. In block 410, a cartridge connection classification may be received from a chassis manager. As explained above, the cartridge and chassis manager may exchange the cartridge connection classification information when the cartridge powers up. The chassis manager may then forward the connection classification information from the cartridge to the network switch.

In block 420, as above, a network connection for the cartridge may be determined based on the connection classification. In one example implementation, the network connection may be determined through the use of VLANs, as described above, and in further detail below. In block 430, the cartridge may be connected to the determined network connection. In one example implementation, connection to a network is determined by the use of VLAN tagging.

In block 440, incoming packets may be tagged with a VLAN identifier based on the received connection classification. As explained above, tagging all incoming packets with a VLAN tag that is determined by the desired network connections provides the network switch with the ability to isolate incoming packets into separate logical networks, despite the fact that the cartridges are actually sharing the same physical switch fabric. Thus, separate networks may be created without requiring redundant switch hardware.

In block 450, incoming packets that are already tagged With a VLAN identifier may be discarded. As mentioned above, in order to ensure that packets from the various cartridges that are destined for the same network, as determined by VLAN ID, the switch may be designated as the entity that tags incoming packets. Thus, if an incoming packet already contains a VLAD identifier, this means that the switch did not tag the packet. This may be an indication of an intrusion attempt, as an external packet source is trying to gain access to the VLAN. By discarding all packets that did not have the VLAN identifier added by the network switch, it can be ensured that such external intrusion attempts fail. In block 460, packets tagged with the VLAN identifier may be sent to the cartridge. Thus, because the switch is the entity that tags the packets, and the switch only tags packets based on the connection classification, it can be ensured that packets containing a given VLAN identifier actually belong to a given network, the network being defined by the VLAN identifier.

I claim:

1. A system comprising:
A chassis manager to receive connection classifications from a cartridge, the connection classifications defining desired network connectivity of the cartridge; and
a network switch to receive the cartridge connection classifications from the chassis manager, the network switch further to configure network connectivity of the cartridge based on the connection classification.

2. The system of claim 1 further comprising:
an external Virtual Local Access Network (VLAN), wherein the connection classifications determine the cartridge connectivity to the external VLAN.

3. The system of claim 1 further comprising:
an infrastructure Virtual Local Access Network (VLAN), wherein the connection classifications determine the cartridge connectivity to the infrastructure VLAN.

4. The system of claim 1 further comprising:
a vendor Virtual Local Access Network (VLAN), wherein the connection classifications determine the cartridge connectivity to the vendor VLAN.

5. The system of claim 1 wherein the network switch is further to:
tag an incoming packet with a Virtual Local Area Network (VLAN) identifier based on the connection classifications of the cartridge when the incoming packet is not tagged with a VLAN identifier; and
discard the incoming packet when the incoming packet is already tagged with a VLAN identifier.

6. The system of claim 1 further comprising:
the cartridge to provide connection classifications to the chassis manager.

7. The system of claim 6 wherein the cartridge classifications are set by a manufacturer of the cartridge.

8. A non-transitory processor readable medium containing a set of instructions thereon, which when executed by a processor cause the processor to:
receive a cartridge connection classification;
determine a network connection for the cartridge based on the connection classification; and
connect the cartridge to the determined network connection.

9. The medium of claim 8 wherein the connection classification is received from a chassis manager.

10. The medium of claim 8 wherein connecting the cartridge to the determined network connection includes instructions to;
tag incoming packets with a Virtual Local Area Network (VLAN) identifier based on the received connection classification.

11. The medium of claim 10 further comprising instructions to:
discard incoming packets that are already tagged with a VLAN identifier.

12. The medium of claim 11 further comprising instructions to:
send packets tagged with the VLAN identifier to the cartridge.

13. A device comprising:
a network connection to connect the device to a network;
a memory storing a connection classification, the connection classification determining to which network the device is connected; and
a device manager to communicate the connection classification to a chassis manager.

14. The device of claim 13 further comprising:
the connection classification including a vendor identifier.

15. The device of claim 13 further comprising:
the connection classification including a Virtual Local Area Network (VLAN) identifier.
